(19) United States
(12) Patent Application Publication
(10) Pub. No.: US 2008/0019373 A1
(43) Pub. Date: Jan. 24, 2008

(54) SYSTEM AND METHOD FOR SCHEDULING DATA TRANSMISSIONS

(75) Inventors: Igor Filipovich, Chicago, IL (US); Ronald T. Crocker, St. Charles, IL (US); John M. Harris, Chicago, IL (US); Ivan N. Vukovic, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/458,829

(22) Filed: Jul. 20, 2006

(51) Int. Cl. H04L 12/56

(52) U.S. Cl. 370/395.4

(57) ABSTRACT

Paging information is transmitted in a first selected one of a plurality of time slots. At least one operating characteristic of the paging system is determined and a determination then made as to whether the at least one operating characteristic of the paging system meets a predetermined criteria (202). When the at least one operating characteristic of the paging system meets the predetermined criteria (204), a data transmission of a first user is scheduled in a second selected one of the plurality of time slots such that the data transmission in the second selected one of the plurality of time slots does not interfere with transmitting the paging information in the first selected one of the plurality of time slots (206).

### FIELD OF THE INVENTION

The field of the invention relates to transmitting data in networks and, more specifically, to scheduling data transmissions in these networks.

### BACKGROUND OF THE INVENTION

Data transmissions that are made between different points in networks are sometimes unsuccessful and, consequently, retransmissions of the data may need to be made if the recipient is ultimately to receive the information. Different types of protocols and approaches have been developed to facilitate the retransmission of the data. For example, the Incremental Redundancy (IR) and Hybrid Automatic Repeat Request (HARQ) protocols are one example of approaches used in cellular and paging systems to facilitate data retransmissions.

In certain types of mobile communication systems, such as paging systems, time slots are used to carry the data. Often in these systems, certain time slots are reserved to carry various types of information to the recipient. For example, certain time slots may be reserved to transmit high priority information (e.g., paging and other control information) while other time slots may be used to send any kind of information, including user data or control information.

In certain HARQ systems, the retransmission attempts are known to occur a fixed period of time after a previous transmission attempt. These systems are known as Synchronous HARQ systems. Knowing when the retransmission attempts will occur reduces the signaling overhead in such systems. For example, a retransmission attempt may occur four time slots after a previous attempt. In these systems, interlaces are frequently used to conduct a number of concurrent different transmission attempts at any time. There may be as many interlaces as the number of time slots between retransmissions. An interlace is considered busy if there is an active transmission attempt using the interlace. Further, such systems often use the IR protocol approach to combine information from retransmission attempts of the information to provide a better result at successfully transmitting the information.

When a data retransmission is attempted in systems using time slots and synchronous HARQ, the first transmission determines when all remaining retransmission attempts will be made. In other words, it determines which interlace will be used for that transmission. The retransmission could potentially be made in a time slot that already contains or is reserved for the transmission of high priority (e.g., paging) information. Unfortunately, this situation frequently creates the problem of the data transmission attempt failing because it is written over by the high priority information and a failure of the IR process to successfully complete the transmission of the data.

Previous systems have attempted to address this problem, but these approaches have proven unsuccessful for a variety of reasons. For instance, in one previous approach, the system simply dropped the data that was to be retransmitted since the paging information took priority. While this approach saved the paging information from erasure, it resulted in a significantly increased data frame erasure rate for the system.

### BRIEF DESCRIPTION OF THE DRAWINGS

The above needs are at least partially met through provision of a system and method for scheduling data transmissions described in the following detailed description, particularly when studied in conjunction with the drawings, wherein:

FIG. 1 is a flowchart of a system for scheduling data transmissions according to various embodiments of the present invention;

FIG. 2 is a flowchart showing one approach for scheduling data transmissions according to various embodiments of the present invention;

FIG. 3 is one example of a communication illustrating approaches for allocating time slots within the communication according to various embodiments of the present invention;

FIG. 4 is another example of a communication illustrating approaches for allocating time slots within the communication according to various embodiments of the present invention; and

FIG. 5 is a block diagram of a scheduler that is used to allocate time slots according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

A system and method are provided whereby data transmissions are made without interfering with the transmission of control or other types of high priority information. In so doing, system efficiency is promoted, data and control information are not lost or erased, and system capacity and the battery life of mobile stations are conserved.

In many of these embodiments, high priority information (e.g., paging information) is transmitted in a first selected one of a plurality of time slots. At least one operating characteristic of the system (e.g., a paging system) is determined. In addition, it is determined whether the operating characteristic meets a predetermined criteria. When the operating characteristic of the system meets the predetermined criteria, a data transmission of a first user is scheduled in a second time slot such that the data transmission in this second time slot does not interfere with transmitting the high priority (e.g., paging) information in the first time slot.

A variety of different operating characteristics may be determined and used to determine whether to transmit the data in the second time slot. For example, the number of transmission retries for a particular message or user may be determined. In another example, a loading condition of the system may be determined. If a loading condition is determined, it may be additionally determined whether the loading condition exceeds a loading threshold.

When the predetermined criteria is met, the data transmission then is scheduled to be made in a time slot that does not interfere with the transmission of information in the high priority (e.g., paging) slot. In this regard, a time slot may be selected for the data transmission that is substantially immediately prior to the first selected one of the plurality of time slots. In another example, a time slot may be selected that has a different interlace than the first selected one of the plurality of time slots.

In addition to the second time slot, other time slots may be used to transmit information. For instance, a data transmission of a second user may be scheduled in a third time slot. In another example, when the operating characteristics of the paging system do not meet the predetermined criteria, the data transmission may be scheduled for a third time slot that is within a threshold number of the first time slot.

Additional techniques may also be used to improve efficiency and the flow of data within the system. For example, additional redundancy may be provided for data transmissions made by one or more users of the system. In addition, the use of multi-user packets may be prevented.

Thus, approaches are provided that allow data to be transmitted in a network without negatively impacting the transmission of high priority information and without loosing the data or the high priority information. The approaches provided herein are efficient to use, and do not negatively impact performance characteristics such as the system capacity or the battery life of mobile stations.

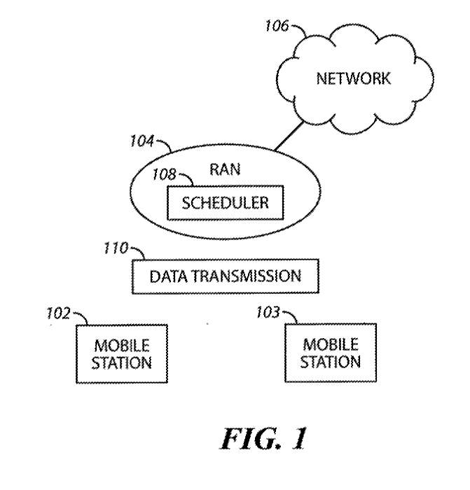

Referring now to FIG. 1, an example of a system for scheduling retransmissions of data is described. The system includes mobile stations 102 and 103, which communicate with a network 104 via a Radio Access Network (RAN) 106 (including a scheduler 108). The network 104 communicates with the mobile stations 102 and 103. It will be understood that other network entities such as switches, servers, and other elements may be used to facilitate communications between the different elements shown in FIG. 1, but are not illustrated here for purposes of simplicity.

The mobile stations 102 and 103 may be any type of mobile communication device. In this regard, the mobile stations 102 and 103 may be cellular phones, pagers, personal digital assistants, or personal computers. Other examples of mobile stations are possible.

The network 104 may be any type of communication network or any combination of networks. For example, the network 104 may be a cellular network, a paging network, a packet data network (e.g., the Internet), a push-to-talk network, or any combination of these networks. Other examples of networks and combinations of networks are possible.

The RAN 106 contains functionality to allow the mobile stations 102 and 103 to communicate with the network 104 and with each other. In this regard, the RAN 106 may include base stations, servers, switches, or any other component or combination of components that implement this functionality.

The scheduler 108 performs the scheduling of transmissions 110 made to and from the mobile stations 102 and 103. For example, when paging information is transmitted in a first selected one of a plurality of time slots, the scheduler 108 may determine or obtain one or more operating characteristics of the system. The scheduler 108 then determines whether these operating characteristics meet some predetermined criteria. When the predetermined criteria is met, the data transmission 110 of a first user (at the mobile station 102) is scheduled in a second selected time slot such that the transmission of the data in the second time slot does not interfere with the transmission of the paging information in the first time slot.

A variety of different operating characteristics may be obtained when determining whether to make the transmission in the second time slot. For example, the number of transmission retries of the users (at the mobile stations 102 and 103) may be determined. In another example, loading conditions of the paging system may be obtained and/or determined. In this case, the scheduler 108 may additionally determine whether the loading conditions meet or exceed a loading threshold.

As mentioned, the scheduler 108 schedules the data transmission in a second time slot that does not interfere with the transmission of high priority information in the first time slot. In this regard, the scheduler 108 may select a time slot that is substantially immediately prior or substantially immediately subsequent to the first time slot. In other words, the scheduler 108 may select a time slot that has a different interlace than the first time slot.

A data transmission of a second user (at the mobile station 103) may be scheduled in a third time slot. In other examples, when the scheduler 108 determines that the operating characteristic of the system do not meet the predetermined criteria, it may schedule the data transmission in the third time slot. The third time slot may be selected using a number of criteria, for instance, it may be a slot within a threshold number of the first time slot.

In addition to scheduling data in particular time slots, the system may use additional techniques to improve efficiency and the flow of data. For example, the scheduler 108 may use additional redundancy for selected data transmissions and/or users. In addition, the scheduler 108 may prevent the use of multi-user packets by users thereby further improving efficiency.

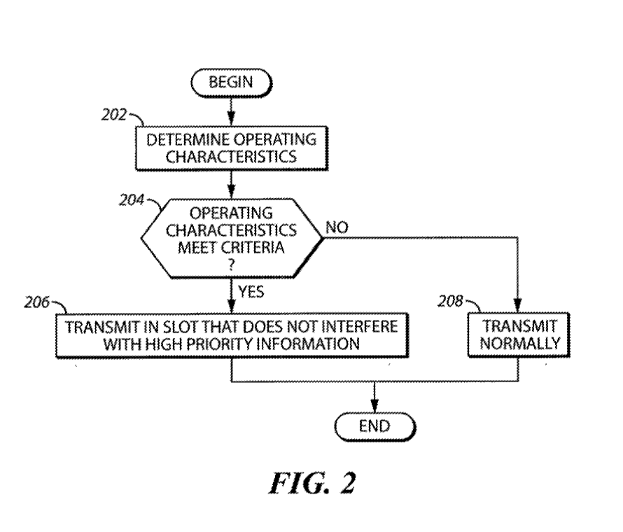

Referring now to FIG. 2, one example of an approach for scheduling the retransmission of data is described. At step 202, the operating characteristics that are to be used to determine whether to reschedule data transmissions are obtained. For example, the operating characteristics may be gathered using various sensors or included in a message or messages that are received by the system.

The operating characteristics may be any type of characteristic or indicator that reflects system performance and/or the performance of mobile stations within the system. For example, the operating characteristics may include the loading conditions of the network. In another example, the operating characteristics may include the number of retries made by a user or a mobile station. Other examples of operating characteristics are possible.

At step 204, it is determined whether the operating characteristics match a predetermined criteria. The predetermined criteria may include any metric or metrics that relate to a maximum (or minimum) acceptable value of the operating characteristics. In one example, the criteria may relate to whether the operating characteristics exceed a threshold. For instance, when the operating characteristics are loading conditions of the network, the criteria may be a threshold value and the system may compare the operating characteristics to the threshold value to determine if the threshold is exceeded.

If the answer at step 204 is negative, at step 208 the scheduling of the data is not altered or adjusted and the transmission occurs within the system as previously conducted. If the answer at step 204 is affirmative, at step 206 the data transmission is scheduled for a time slot than is different than the high priority time slots such that the transmission of the data does not interfere with the transmission of information in the high priority slots. For example, the data transmission may be scheduled for a time slot that immediately precedes or is within a predetermined number of the high priority time slots. Further, the transmission may occur in a different interlace than the interlace of the high priority time slots. By scheduling the data in a time slot in these approaches, interference with the high priority information is avoided while at the same time allowing for the transmission of the data to a recipient.

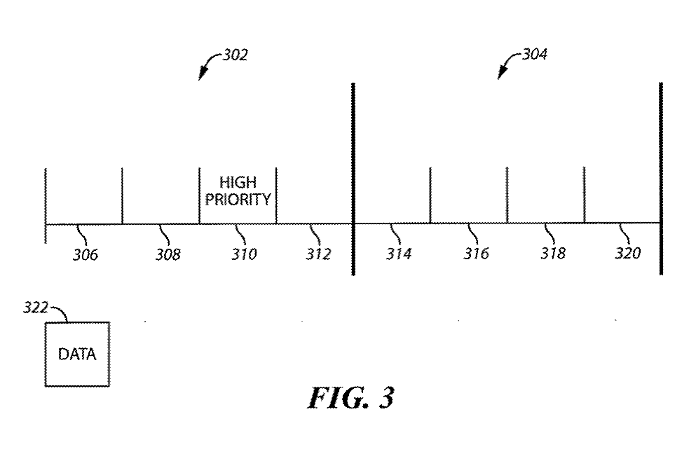

Referring now to FIG. 3, one example of a communication 300 and approaches for scheduling the transmission of information within the communication 300 are described. The communication 300 includes a first data frame 302 and a second data frame 304. As shown, each of the data frames 302 and 304 include a plurality of time slots 306-320. For the frame 302, slots 306 and 310 may be a first interlace and slots 308 and 312 may be another interlace. For the frame 304, the slots 314 and 318 may be one interlace and the slots 316 and 320 may be another interlace. Data may be attempted to be initially transmitted in the first slot of the interlace (e.g., slot 306) and retransmitted in another slot in the interlace (e.g., slot 310).

During the course of operation, data 322 may be required to be transmitted between two points (e.g., between two mobile stations) within a network. Using the approaches described herein, a time slot (or time slots) may be selected to transmit the data 322 such that transmission of the data and any potential data retransmission does not interfere with the transmission of the high priority information in slot 310. For example, a scheduler may determine to transmit the information in a slot 308 such that any retransmission will be made in slot 312. Consequently, no interference will occur of the transmission of the data in the slot 308 or a potential retransmission in slot 312. Data would not be transmitted in the interlace (slots 306 and 310) since a potential retransmission would interfere with the high priority information being transmitted in slot 310.

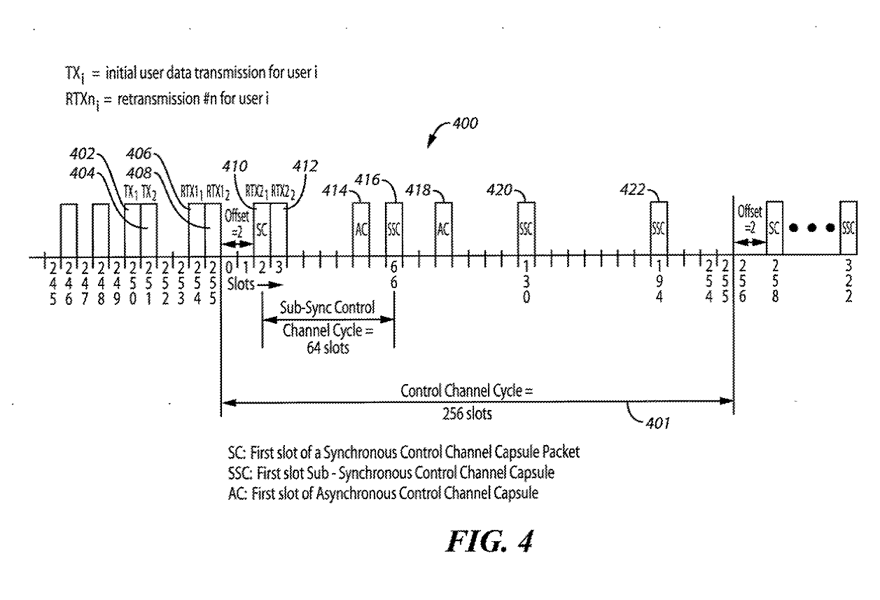

Referring now to FIG. 4, another example of a communication 400 is described as well as approaches for scheduling data within the communication 400. In this example, the communication 400 is made according to the High Rate Packet Data Air Interface (HRPDA) protocol. Specifically, a control channel cycle (frame) 401 comprises two hundred fifty-six slots. A time slot 402 of the previous frame is am initial user data transmission of a first user. A slot 404 is an initial data transmission of a second user. A slot 404 is a first retransmission attempt for the first user and slot 408 is a first retransmission slot for the second user.

In the frame 401, slot 410 is a second retransmission slot for the first user and the slot 412 is the second retransmission slot for the second user. The slot 410 is also the first slot of a Synchronous Control Channel Capsule Packet (SC). Slot 414 is the first slot of am Asynchronous Control Channel Capsule (AC). Slots 416, 420, 422 are slots for the transmission of Sub-Synchronous Control Channel Capsules (SSCs).

In the example of FIG. 4, a scheduler is used to determine when the operating conditions meet a predetermined criteria, for example, when the loading conditions of the system meet or exceed a threshold. The data that may need to be retransmitted is then scheduled so as to avoid possible retransmission in the control slots 410, 414, 416, 420, and 422. For example, initial transmission of data may be removed so retransmissions made in frame 401 are made in the first two slots in the frame.

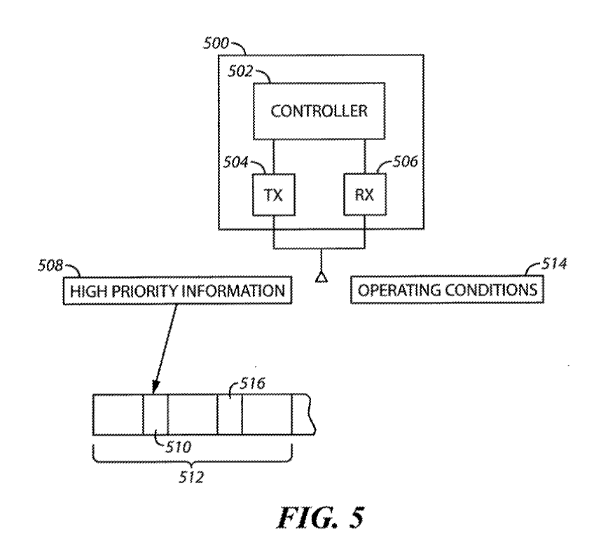

Referring now to FIG. 5, one example of a scheduler 500 is described. The scheduler 500 includes a controller 502, a transmitter 504, and a receiver 506.

The transmitter 504 transmits high priority information 508 in a first selected one 510 of a plurality of time slots 512. The receiver 506 receives information 514 indicative of an operating characteristic or characteristics of a system or network, for example, a paging system or network.

The controller 502 is adapted (e.g., programmed) to determine whether the operating characteristics received at the transmitter 504 meet a predetermined criteria. When the operating characteristic meets the predetermined criteria, the controller 502 reschedules the data transmission to be made in a second slot 516 such that the data transmission in this second slot 516 does not interfere with transmitting the high priority information in the slot 510. The high priority information may include a variety of different types and/or forms of information such as paging information or other types of control information.

The controller 502, when determining whether to reschedule the transmission of the data, may rely upon a number of different operating conditions. For example, the controller 502 may determine usage history of the user, or a radio frequency (RF) usage of the user under heavy loading conditions. Other factors may also be considered by the controller 502. As mentioned, once the operating conditions are determined, the controller 502 determines whether these operating conditions meet the predetermined criteria and if a match is determined, reschedules the data transmission accordingly.

Thus, approaches are provided that allow data to be transmitted in a network without negatively impacting the transmission of control information and without loosing the data or the control information. The approaches are efficient to use, and do not negatively impact system operating characteristics such as system capacity or mobile station parameters such as the battery life of the mobile station.

Those skilled in the art will recognize that a wide variety of modifications, alterations, and combinations may be made with respect to the above described embodiments without departing from the spirit and scope of the invention, and that such modifications, alterations, and combinations are to be viewed as being within the scope of the invention.

What is claimed is:

1. A method for scheduling user traffic in a network comprising:
in a paging system:
transmitting paging information in a first selected one of a plurality of time slots;
determining at least one operating characteristic of the paging system;
determining whether the at least one operating characteristic of the paging system meets a predetermined criteria; and
when the at least one operating characteristic of the paging system meets the predetermined criteria, scheduling a data transmission of a first user in a second selected one of the plurality of time slots, such that the data transmission in the second selected one of the plurality of time slots does not interfere with transmitting the paging information in the first selected one of the plurality of time slots.

2. The method of claim 1 wherein determining at least one operating characteristic comprises determining a number of transmission retries.

3. The method of claim 1 wherein determining at least one operating characteristic comprises determining a loading condition of the paging system.

4. The method of claim 3 wherein determining whether the at least one operating characteristic of the paging system meets a predetermined criteria comprises determining whether the loading condition exceeds a loading threshold.

5. The method of claim 4 wherein scheduling the data transmission comprises selecting the second selected one of the plurality of slots such that the second selected one of the plurality of slots occurs at a slot selected from a group comprising: a slot substantially immediately prior to the first selected one of the plurality of time slots, and a slot having a different interlace than the first selected one of the plurality of time slots.

6. The method of claim 5 further comprising scheduling a data transmission of a second user in a third selected one of the plurality of time slots.

7. The method of claim 1 further comprising when the operating characteristic of the paging system do not meet the predetermined criteria, scheduling the data transmission to be made in a third time slot, the third time slot being within a threshold number of the first selected of the plurality of time slots.

8. The method of claim 1 further comprising providing additional redundancy for the data transmission.

9. The method of claim 1 further comprising preventing the use of multi-user packets.

10. A method of scheduling data transmissions in a network comprising:
determining operating conditions of the network;
when the operating conditions of the network do not meet a predetermined criteria, identifying a first user having predictable radio frequency (RF) characteristics and scheduling first transmissions of the first user in a first time slot, the first time slot being different from a high priority time slot; and
scheduling a second data transmission of a second user in a second time slot, the second time slot being different from the first time slot and the high priority time slot.

11. The method of claim 10 wherein the high priority time slot comprises a paging time slot.

12. The method of claim 10 further comprising providing redundancy in the first and second data transmissions for the first and second users.

13. The method of claim 10 wherein determining the operating conditions comprises determining the loading conditions of the network.

14. The method of claim 13 further comprising identifying delay tolerant transmissions of the first and second users and, when the loading condition are light, not scheduling the delay tolerant transmissions within a predetermined number of slots of the high priority time slot and a third time slot.

15. A traffic scheduler comprising:
a transmitter for transmitting high priority information in a first selected one of a plurality of time slots;
a receiver for receiving information indicative of at least one operating characteristic of a paging system;
a controller coupled to the transmitter and receiver, the controller being adapted to determine whether the at least one operating characteristic meets a predetermined criteria and when the at least one operating characteristic meets the predetermined criteria, to reschedule a data transmission of a user to a second selected one of the plurality of time slots such that the data transmission does not interfere with transmitting the high priority information.

16. The traffic scheduler of claim 15 wherein the high priority information comprises paging information.

17. The traffic scheduler of claim 15 wherein the controller is adapted to determine a usage history of the user.

18. The traffic scheduler of claim 15 wherein the controller is adapted to determine a radio frequency (RF) usage of the user under heavy loading conditions.

19. The traffic scheduler of claim 18 wherein the controller is adapted to delay the data transmission to a third time slot, the third time slot being different from the first time slot.
